(19) United States
(12) Patent Application Publication
(10) Pub. No.: US 2014/0180960 A1
(43) Pub. Date: Jun. 26, 2014

(54) Method For Issuing a Ticket to a Customer to a Queue, a Mobile Device and a Queue Ticket Terminal

(71) Applicant: TELEFONAKTIEBOLAGET L M ERICSSON (PUBL), Stockholm (SE)

(72) Inventors: Mats SAGFORS, Kyrkslatt (FI); Jari ARKKO, Kauniainen (FI); Fredrik GARNEIJ, Goteborg (SE); Jan MELEN, Espoo (FI)

(73) Assignee: Telefonaktiebolaget L M Ericsson (publ), Stockholm (SE)

(21) Appl. No.: 13/724,109

(22) Filed: Dec. 21, 2012

(30) Foreign Application Priority Data
Dec. 20, 2012 (EP) PCT/EP2012/076424

(51) Int. Cl. G06Q 30/02

(52) U.S. Cl. CPC G06Q 30/0281
USPC 705/346

(57) ABSTRACT

In one aspect, there is provided a method for issuing a ticket to a customer to a queue of a service function. In some embodiment the method includes: providing a queue ticket terminal in a predetermined space associated with said service function; and enabling a customer to be allocated a queue ticket from said terminal. The method further comprising: detecting, in a mobile device associated with said customer, whether said queue ticket terminal is in the vicinity of said mobile device; transmitting a queue ticket request from said mobile device to said queue ticket terminal; and, receiving, in said mobile device and in response to said queue ticket request, a queue position message comprising information relating to the customer's position in said queue.

### CROSS REFERENCE TO RELATED APPLICATIONS

This application claims priority to International Patent Application No. PCT/EP2012/076424, filed on Dec. 20, 2012, which application is incorporated by reference herein.

### TECHNICAL FIELD

The present invention relates to a method for issuing a ticket to a customer to a queue of a service function, comprising providing a queue ticket terminal in a predetermined space associated with said service function; and enabling a customer to be allocated a queue ticket from said terminal.

The invention also relates to a mobile device being associated with a customer of a queue to a service function in a predetermined space. The invention also relates to a queue ticket terminal for positioning in a predetermined space having a service function, said terminal being configured for allocating a ticket for a queue to a customer.

### BACKGROUND ART

It is common today that when a customer enters a bank office, an airport check-in desk, a shop or a similar service function, the customer may be required to take a queue ticket in order to obtain a place in a queue to said service function.

For this reason, the service function is equipped with a queue ticket terminal, which is arranged so that by pushing on a button, a queue ticket in the form of a paper slip is produced. This queue ticket carries information regarding a queue number for the customer, which consequently indicates the customer's place in the queue.

Normally, the position in the queue which is currently being served at the service function is also shown on a sign or a screen which is visible for those being in the vicinity of the service function.

The advantage with this known process is that the customer does not have to actually stand in line to wait for the customer's queue number to come up, but may instead sit and wait in a sofa, or may also just move around while waiting for the queue to move forward.

A disadvantage with the process is that the customer must always be in visual contact with the sign showing the number of the customer which is currently being served. If a customer which holds a queue ticket walks away out of sight of the service function and then misses when his queue number comes up, he will have to go back and pick a new queue ticket. This means that he will be last in line again, which of course is annoying.

Based on the issues explained above, there is a need for improved systems and methods in order to avoid the above-mentioned problem.

### SUMMARY OF THE INVENTION

The object of the invention is to provide an improved method for issuing tickets to a customer in a service function such as a bank office, shop, government's office or similar, in which the customer may keep the place in the queue without having to be in close proximity to the service function.

The present invention provides a method for issuing a ticket to a customer to a queue of a service function, comprising: providing a queue ticket terminal in a predetermined space associated with said service function; and enabling a customer to be allocated a queue ticket from said terminal. The invention also comprises: detecting, in a mobile device associated with said customer, whether said queue ticket terminal is in the vicinity of said mobile device; transmitting a queue ticket request from said mobile device to said queue ticket terminal; and, receiving, in said mobile device and in response to said queue ticket request, a queue position message comprising information relating to the customer's position in said queue.

The advantage with the invention is that the customer may use a mobile device to watch how the queue progresses, i.e. the customer does not have to stand close to the service function while waiting for his queue number to come up next. This means that the customer is free to walk around or do some other shopping elsewhere while still staying in the queue. This is a flexible and comfortable way of organizing a queue.

According to an embodiment, the invention can be arranged with a step of receiving—in said mobile device—a waiting time message indicating an expected time period for the customer to reach the front of the queue. Consequently, since the customer is informed of the expected waiting time in the queue, he may plan his activities during the waiting time in a flexible manner.

Furthermore, according to an embodiment, the method can be arranged with a step of transmitting, upon request from said mobile device, a rejection message to said queue ticket terminal, corresponding to the customer deleting the corresponding queue ticket. This is useful if the customer does not wish to remain any longer in the queue. Also, according to an embodiment, the method comprises, upon request from said mobile device, transmitting a queue decline message from said mobile device corresponding to the customer moving further back a selected number of places in said queue. This means that the customer does not have to actually step out of the queue, but may simply move back a certain number of places further down the queue, for example 10 places further back. This will give the customer more time to do other activities before returning to the service function.

According to an embodiment, the method comprises a step of detecting whether the mobile device is in the vicinity of the queue ticket terminal by means of at least one of a near-field communication process, a cellular mobile telephone network process, a Wi-Fi network process or a pilot tone detection process.

Also, the method may comprise, according to a further embodiment, a step of running an authorization process in which it is checked whether the identity of the mobile device is authorized to access said queue. This is an efficient way of allowing only authorized persons to be allowed to obtain a place in the queue.

According to further embodiment, the method comprises: transmitting, from said mobile device, queue ticket requests to at least two queues to corresponding service functions, in which the customer is enabled to be allocated queue tickets; and receiving, in said mobile device and in response to said queue ticket requests, a queue position message comprising information related to the customer's queue positions in each of said queues having been selected.

Such an embodiment is useful when the customer is located for example in a large shopping mall with many shops and other similar service functions. The customer may then take a queue ticket to several service functions at the same time and follow several queues.

The invention also relates to a mobile device which is associated with a customer of a queue to a service function in a predetermined space. The mobile device comprises: detection means configured to detect the presence of a queue ticket terminal in the vicinity of the mobile device and in said space; a wireless communication unit configured to send a queue ticket request from said mobile device and receive, in response to said queue ticket request, a queue position message comprising information related to the customer's position in said queue; thereby acquiring a ticket to said customer of a queue to said service function,

Furthermore, the invention relates to a queue ticket terminal for positioning in a predetermined space having a service function, said terminal being configured for allocating a ticket for a queue to a customer. The terminal further comprises: detection means for determining whether the queue ticket terminal is in the vicinity of a mobile device being associated with a customer in, or in the vicinity of, said space; and ticket-issuing means for transmitting a queue position message to said mobile device comprising information related to the customer's position in said queue.

### BRIEF DESCRIPTION OF THE DRAWINGS

The invention will be described more fully hereinafter with reference to the accompanying drawings, wherein:

FIG. 1 shows a schematic view of a space in which the invention can be used;

FIG. 2 is a flow chart of the method according to the invention, according to an embodiment;

FIG. 3 is a flow chart corresponding to a further embodiment of the invention;

FIG. 4 is a flow chart corresponding to yet another embodiment; and

FIG. 5 shows in a schematic manner the operation of the invention.

### DETAILED DESCRIPTION OF EMBODIMENTS

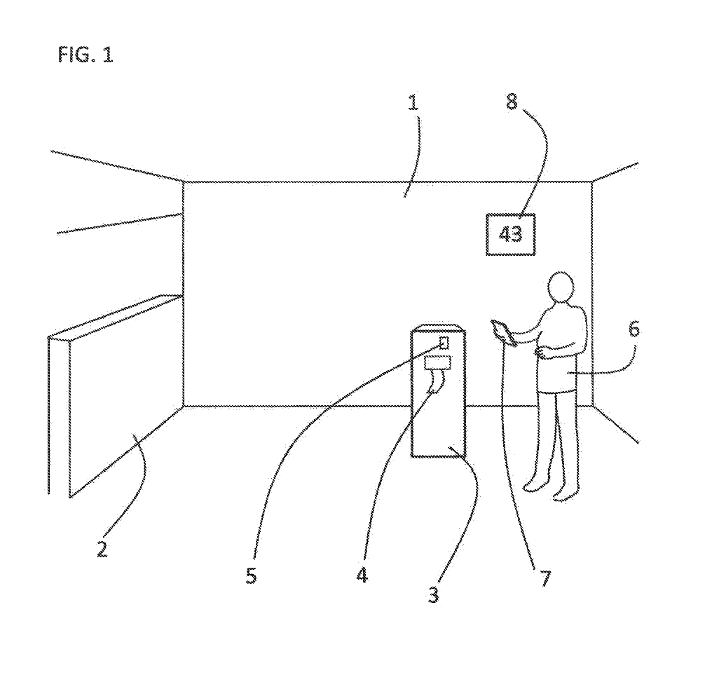

FIG. 1 is a simplified perspective view of a space 1 in which the invention can be used. Purely as an example, it can be assumed that according to an embodiment, the space 1 is constituted by a service function such as in a bank office. Alternatively, the embodiment can be used in other similar spaces—and with similar service functions—such as a shop, an airport check-in facility, a hotel reception, a taxi station, a government's office, a doctor's or dentist's reception, a pharmacy or a similar environment having at least one service function in which a queue of customers can be expected to be formed.

According to an embodiment, such a service function is illustrated in FIG. 1 by means of a counter 2 in a bank office 1. When the bank office 1 is open, it is common that a queue of customers to the counter 2 is formed so that the customers can be serviced one at a time.

Furthermore, in order to organize a queue to the counter 2, there is provided a queue ticket terminal 3. The terminal 3 is arranged for providing a queue ticket 4 which according to an embodiment is in the form of a paper slip which is fed out of the terminal 3 by pressing on a corresponding button 5. This queue ticket 4 indicates a position in the queue.

The above-mentioned way of organizing a queue is according to known technology, i.e. it follows the traditional way of providing a queue ticket in the form of a paper slip indicating a customer's place in a queue. To this end, the queue ticket terminal 3 is configured for receiving input from the service function 2 that a customer has been served and that the next customer in the queue is allowed to come to the counter 2.

It should be noted that according to an embodiment, the queue ticket automat 3 is also configured for issuing a “virtual” queue ticket, i.e. paperless queue ticket which can be obtained by a customer 6 approaching the terminal 3 and carrying a mobile device 7 which is configured to cooperate with the terminal 3. The terminal 3 is also connected to a sign or screen 8 which indicates clearly to everyone in the bank office 1 which queue number is currently being served at the counter 2.

The mobile device 7 can be a mobile telephone, a so-called smartphone, a tablet computer, a laptop computer or a similar handheld or otherwise mobile device for communication purposes.

A procedure for issuing a “virtual” queue ticket to the customer 6 through the use of the mobile device 7 being associated with the terminal 3—and thereby being allocated a place in the queue to the service function 2—will now be described in greater detail.

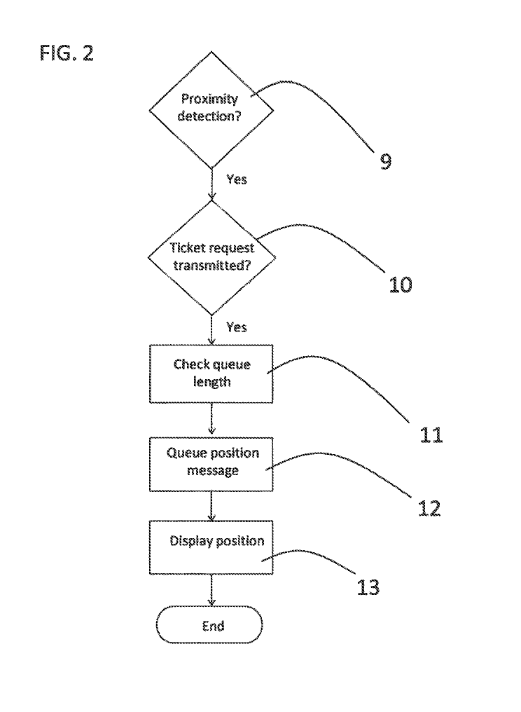

When the customer 6 enters the bank office 1 and approaches the queue ticket terminal 3, a procedure for issuing a queue ticket to the customer can be initiated. This is suitably done by launching a dedicated application program which can be run in the mobile device 7. The next steps in this process will now be described with reference to FIG. 2, which is a flow chart of a method according to an embodiment of the invention, in its most basic form.

As indicated in FIG. 2, the process for issuing a queue ticket begins with a step of detecting whether the mobile device 7 is located in the vicinity of the queue ticket terminal 3 (step 9). According to an embodiment, this is carried out by means of wireless technologies, suitably by means of a Bluetooth connection. Such a connection is established by allowing the mobile device 7 (which is provided with Bluetooth functionality) to find the terminal 3 when it is in the vicinity of the mobile device 7. According to technology which is known as such, this is done by allowing the mobile device 7 to transmit inquiry signals to the terminal 3 and also to allow the mobile device 7 to detect inquiry response signals from the terminal 3 in order to establish a communication link between the mobile device 7 and the terminal 3 when these devices are sufficiently close to each other, suitably approximately 8-10 meters or less.

According to alternative embodiments, the detection step in which it is determined whether the mobile device 7 is in the vicinity of the terminal 3 can be carried out in alternative ways. For example, Zigbee-based technology can be used for this purpose. Also, near field communication (NFC) systems such as RFID-based systems, in which the mobile device operates as a reading unit which cooperates with a tag which is arranged in the terminal, can be used. In such a case, the tag can be provided with an identification code in order to provide correct authentication.

Other wireless technologies such as Wi-Fi connections or cellular mobile telephone networks can also be used, alone or in combination, in order to establish a wireless link between the mobile device 7 and the terminal 3.

A further way of detecting whether the mobile device 7 is close to the terminal 3 is by using bar code technology, i.e. wherein that mobile device 7 operates as a scanner of an identification bar code which is carried by the terminal 3. Furthermore, a pilot tone detection process can be implemented, wherein an identification signal in the form of a pilot tone can be transmitted by the terminal 3 and detected by the mobile device 7.

With reference to FIG. 2, the process for issuing queue tickets continues by awaiting a queue ticket request from the mobile device 7 (step 10). The queue ticket request corresponds to a message being transmitted from the mobile device 7 to the terminal 3 and requesting a “virtual” queue ticket, i.e. a place at the end of the queue to the counter 2.

When the terminal 3 has received the queue ticket request, it checks the current length of the queue, i.e. to determine which is the next available queue number (step 11). The customer 6 is then given a queue place which is last in the queue, after which the terminal 3 transmits a queue position message to the mobile device 7 (step 12). This means that the mobile device 7 has received information relating to the customer's 6 position in the queue.

According to an embodiment, the queue position message is suitably also displayed on a display (not visible in FIG. 1) in the form of a message such as “You have place number 76 in this queue” (step 13). According to an embodiment, the terminal 3 is also configured to include information in the queue position message related to the number of the queue ticket which corresponds to the customer currently being served at the counter 2. This number is suitably also displayed on the mobile device 7 in the form of a message such as “Number 43 is currently being served”. This number is suitably also shown on a sign 8 being positioned in the bank office 1, for example on a wall, clearly visible to those who are in the bank office 1.

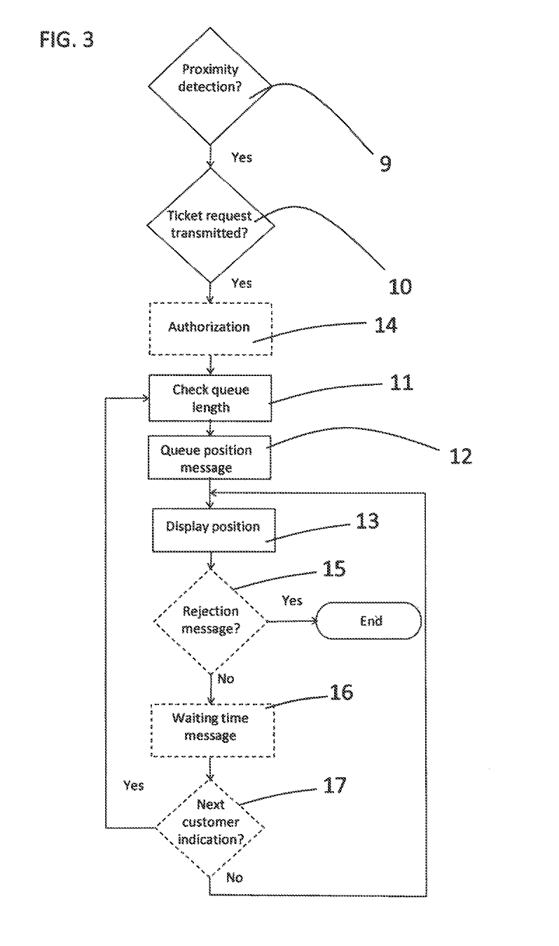

FIG. 3 shows an embodiment with certain optional steps which can be implemented. Steps 9, 10, 11, 12 and 13 are carried out as described above. Furthermore, an authorization step (step 14) is carried out, in which it is checked whether the mobile device 7 is authorized to obtain a queue ticket to the queue in question. This is carried out by means of an exchange of information between the mobile device 7 and the terminal 3, wherein the terminal 3 request a certain code and grants access to the queue if the mobile device 7 replies with the correct code. If the code in the reply is not correct, no queue ticket will be issued to the customer 6.

Furthermore, according to the embodiment, the mobile device 7 is used to transmit a rejection message if the customer 6 wishes to give up the place in the queue, i.e. by deleting the “virtual” queue ticket (step 15). In such a step, the rejection message is transmitted to the terminal 3, which subsequently deletes the queue number in question.

Furthermore, FIG. 3 indicates an embodiment in which a step of providing a waiting time message (step 16) is provided. In order to accomplish this, the terminal 3 is configured for calculating an estimated waiting time for a customer 6 who has obtained a queue ticket. Such an estimate of the waiting time is calculated as an average service time for each customer at the counter 2 multiplied with a number of customers being positioned in front of the customer 6 in the queue.

The waiting time can also be continuously updated as the customer 6 approaches the front of the queue. Consequently, the terminal 3 transmits said waiting time message to the mobile device 3 which preferably is arranged for displaying the updated waiting time on a display.

Furthermore, the terminal 3 is preferably configured to detect each time a customer is received at the counter 2. This constitutes a “next customer indication” which is used for updating the queue (step 17). This means that when the terminal 3 detects that the queue has progressed one step so that a new customer is allowed to the service counter 2, the terminal 3 proceeds to step 11 in which the current queue length is checked and step 16 in which an updated waiting time message message is transmitted to the mobile device 7.

The main advantage with the method as described is that the customer 6 which has received a virtual queue ticket may move around freely while waiting to reach the front of the queue. In other words, the customer 6 does not have to stay in the bank office 1 in order to watch the screen 8 with the current number being served. In fact, the customer 6 is free to take a walk or perhaps do other shopping while still waiting in the queue and keeping the queue number.

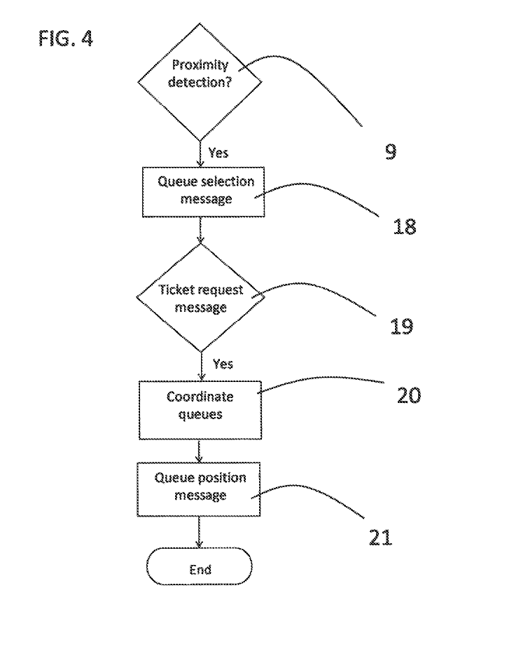

FIG. 4 indicates a further embodiment in which the customer is in a space which comprises more than one service functions, each having a queue of its own. In other words, this situation means that the customer has the choice of standing in more than one “virtual” queues. This can be the case, for example, when the customer is in a large shopping mall with a plurality of shops and other service functions.

As indicated in FIG. 4, the first step of such a process (step 9) is a step of detecting whether the mobile device is located in the vicinity of the queue ticket terminal. This is implemented as described above with reference to FIG. 1. If this is the case, the method proceeds to a step in which the terminal 3 transmits a queue selection message to the mobile device (step 18), including information related to which queues the customer has the option of obtaining queue tickets for. Next, the mobile device is used to transmit a queue selection message (step 19), choosing those queues for which the customer wishes to obtain a queue ticket.

In the following it is assumed, as an example only, that the customer wishes to obtain queue tickets to two different queues, i.e. Q1 and Q2. The queue Q1 may for example correspond to a bank office and the queue Q2 may for example correspond to a pharmacy. It can be expected that Q1 and Q2 are situated relatively close to each other and that the customer intends to first go to Q1 and subsequently continue to Q2.

When the terminal 3 has received a ticket request message (step 19), a step of coordinating the queues follows (step 20). According to an embodiment, this means that the terminal checks the current queue lengths in Q1 and Q2 to determine the customer's positions in these queues. As an example only, it can be assumed here that the customer's queue position in Q1 is number 20 and the customer's queue position in Q2 is 25.

According to an embodiment, the step of coordinating the queues (step 20) comprises a calculation of the most optimal overall waiting time for the customer. For example, if it turns out that the queues move forward in a manner so that the customer comes to the front of both these queues at the same time, this would cause an annoying situation since the customer cannot be at the front of both queues at the same time. For this reason, the step of coordinating the queues (step 20) comprises adapting the queue positions of the queues so that the total waiting time in the queues is minimized. In the example involving the queues Q1 and Q2, this can be done by choosing (either automatically or through the mobile device) that the queue Q1 has the highest priority and that the customer intends to go to the corresponding counter as soon as the queue number at Q1 shows up. However, if the terminal detects that the time between the expected point in time when the customer reaches the front of Q1 and the expected point in time when the customer reaches the front of Q2 is shorter than a certain value—i.e. a minimum transfer time from Q1 to Q2—the terminal moves the customer a certain number of places further down the queue Q2. This means that when the customer is finished at Q1, it will be suitable for the customer to go directly to Q2 because it can be expected that the customer may reach the front of Q2 very shortly.

The calculation of the minimum transfer time is preferably influenced by the expected time it takes for the customer to move, either by means of a vehicle or by walking, from Q1 to Q2.

Based on the principles above, the terminal transmits a queue position message to the mobile devices with the current, updated queue positions (step 21) so that the customer always knows his current positions in the queues.

According to an embodiment, the method as described with reference to FIG. 4 can also be provided with steps 14, 15,16 as described above with reference to FIG. 3.

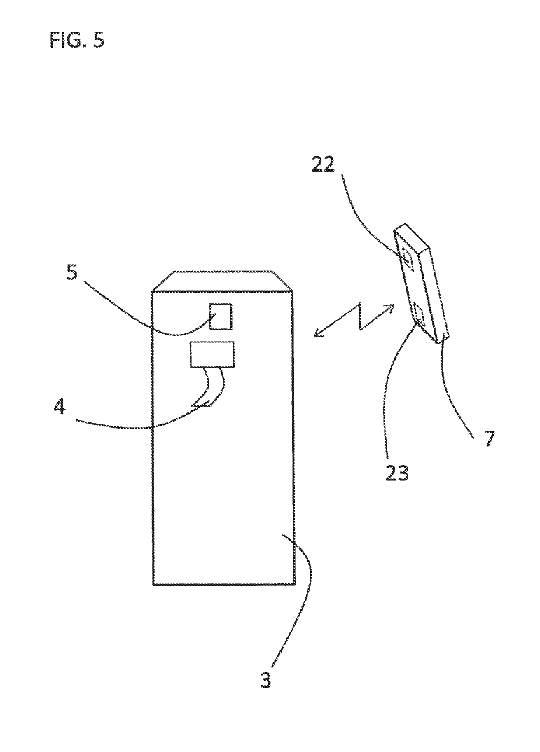

With reference to FIG. 5, which is a schematic view of the queue ticket terminal 3 and the associated mobile device 7, it is noted that the terminal 3 is also arranged for issuing tickets in the form of the more traditional paper slips, as indicated by means of reference numeral 4. This procedure is provided by means of the terminal 3 is due to the fact that it can be expected that not all customers entering the bank 1 are in fact not equipped with a mobile device. In order to receive a paper queue ticket 4, it is necessary to press the button 5 which suitably is provided on the terminal 3.

Furthermore, the mobile device 7 comprises detection means 22 configured to detect whether the queue ticket terminal 3 is in the vicinity of the mobile device 7. In accordance with an embodiment, as described above with reference to FIG. 2, this is carried out by means of Bluetooth technology but a number of other wireless technologies are also suitable for this detection procedure, as described above.

The mobile device 7 device also comprises a wireless communication unit 23 which is configured to send the ticket request from the mobile device 7, as described above and as indicated by means of reference numeral 10 in FIG. 2. The wireless communication unit 23 is also arranged for receiving (in response to a queue ticket request) a queue position message comprising information related to the customer's 6 position in the queue. In this manner, a queue ticket is acquired by the customer.

Consequently, such a queue ticket corresponds to an acknowledgement being issued by the terminal 3 in response to a request from the mobile device 7 which is directed to the terminal 3 and inquiring for a place in the queue. The mobile device 7 cooperates with the terminal 3 when the customer 6 starts a certain program which is stored in the mobile device 7 and which allows the customer to send a queue ticket request message to the terminal 3.

The invention is not limited to the embodiments described above but can be varied within the scope of the appended claims. For example, the terminal 3 can be positioned inside a space 1 such as shown in FIG. 1, but can also be positioned outside such a space. Also, the mobile device can be a tablet computer, a laptop computer, a so-called PDA (personal digital assistant) or a similar handheld or otherwise mobile device which is configured for communication purposes.

1. A method for issuing a ticket, to a customer having a mobile device, to a queue of a service function, comprising:
the mobile device detecting whether a queue ticket terminal is in the vicinity of said mobile device;
the mobile device transmitting a queue ticket request to said queue ticket terminal; and
the mobile device receiving in response to said queue ticket request a queue position message comprising information relating to the customer's position in said queue.

2. The method according to claim 1, further comprising:
receiving, in said mobile device, a waiting time message indicating an expected time period for the customer to reach the front of the queue.

3. The method according to claim 1, further comprising, upon request from said mobile device, transmitting a rejection message to said queue ticket terminal, corresponding to the customer deleting the corresponding queue ticket.

4. The method according to claim 1, further comprising: upon request from said mobile device, transmitting a queue decline message from said mobile device corresponding to the customer moving further back a selected number of places in said queue.

5. The method according to claim 1, further comprising:
detecting that said mobile device is in the vicinity of said queue ticket terminal by means of at least one of a near-field communication process, a cellular mobile telephone network process, a wifi network process or a pilot tone detection process.

6. The method according to claim 1, further comprising:
running an authorization process in which it is checked whether the identity of said mobile device is authorized to access said queue.

7. The method according to claim 1, further comprising:
transmitting, from said mobile device, queue ticket requests to at least two queues to corresponding service functions, in which the customer is enabled to be allocated queue tickets; and
receiving, in said mobile device and in response to said queue ticket requests, a queue position message comprising information related to the customer's queue positions in each of said queues having been selected.

8. A mobile device being associated with a customer of a queue to a service function in a predetermined space, comprising:
a detector configured to detect the presence of a queue ticket terminal in the vicinity of the mobile device and in said space; and
a wireless communication unit configured to send a queue ticket request from said mobile device and receive, in response to said queue ticket request, a queue position message comprising information related to the customer's position in said queue.

9. A queue ticket terminal for positioning in a predetermined space having a service function, said terminal being configured for allocating a ticket for a queue to a customer, comprising:
a detector for determining whether the queue ticket terminal is in the vicinity of a mobile device being associated with a customer in, or in the vicinity of said space; and
a transmitter for transmitting a queue position message to said mobile device comprising information related to the customer's position in said queue.

10. The method according to claim 1, further comprising issuing queue tickets in the form of slips of paper or similar material by means of said terminal upon request from said customer.

11. The method according to claim 1, further comprising:
coordinating said queue positions based at least on a combined waiting time to said service functions being minimized; and
preparing said queue position message based on said coordinating step.
